(19) United States
(12) Patent Application Publication
(10) Pub. No.: US 2006/0228434 A1
(43) Pub. Date: Oct. 12, 2006

(54) Forming tool for producing shaped foam bodies

(76) Inventor: Thomas Freser-Wolzenburg, Garbsen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/567,998

(22) PCT Filed: Aug. 10, 2004
(86) PCT No.: PCT/EP04/08914

§ 371 Date: Feb. 10, 2006

(30) Foreign Application Priority Data
Aug. 14, 2003 (DE) 10337559.7

(51) Int. Cl. B29C 44/58

(52) U.S. Cl. 425/134; 425/4 R

(57) ABSTRACT

A molding tool for producing molded foam bodies, particularly polyurethane molded foam bodies, by filling a mold with an expandable reactive mixture, whereby the shaping inner surfaces of the tool are provided with a microstructuring with the lotus leaf effect and/or with a durable nonstick coating made of a fluoroplastic or of a diamond-like coating.

### TECHNICAL AREA

The present invention relates to a molding tool for producing molded foam bodies, in particular polyurethane molded foam bodies, by filling an expandable reactive mixture into a mold.

Molded foam bodies tend to adhere to the surfaces of molding tools in which they are produced, thus rendering the removal of the molded foam bodies very difficult or even impossible. In addition, the wall adherence and the resulting flow shearing forces when filling the cavity with foam result in modification of the foam structure near the surface of the molded foam body. Various options exist for solving this problem.

### BACKGROUND INFORMATION

The most frequently used method for reducing wall adherence is the use of an additional parting agent. DE-PS 1 131 873 describes such a method. The parting agents contain an excess of materials which react with the free isocyanate groups during the foaming process. By applying the parting agent to the inner surfaces of the tool prior to each foaming operation, the foam part is prevented from adhering to the mold walls. The disadvantage here is the formation of overspray, which contaminates the equipment and represents a health and environmental hazard. The solvents contained in the parting agents require aeration times. Applying the parting agent to the mold also requires time. Furthermore, a portion of the parting agent always remains on the molded foam part, which is often undesirable, because it makes the use of the thus produced parts difficult. In addition, chemical reactions of the parting agent with the reactive mixture during and even after the foaming process have undesirable effects on the characteristics of the component, in particular on the open surface porosity. The cavity cleaning cycles, which are necessary after a certain time due to adhering residues, result in a further reduction in productivity.

Therefore, DE-OS 2 055 772 describes molding tools whose shaping surfaces are provided with a relatively thick base layer of copper or nickel onto which a thin chromium layer is applied. The anti-adherence characteristics of chromium make it possible to avoid the use of a parting agent. However, in this embodiment, the reduction in the potential of the chromium layer during foaming is a problem, and the potential must therefore be built up again after each foaming operation. Due to the sensitivity of the chromium layer, the parting agent cannot be totally dispensed with, in particular in the case of a large number of parts.

DE 38 37 351 C1 describes another option for improving the parting characteristics in which internal parting agents are added to the components for foam formation. During the manufacture of polyurethane molded foam bodies, liquid polybutadiene is added to the polyol constituent. However, this not only affects the foam surfaces by reducing the foam adhesion, but the foaming process, the chemical characteristics, and the later physical properties of the molded bodies are also affected. It has also been found that the parting effect is insufficient for completely dispensing with external parting agents.

Finally, DE 197 13 566 C2 describes a method in which an ionized gas mixture containing positively charged air is blown into the foaming mold at high pressure for building up the potential of the anti-adhesion layer and thus the repulsion effect again before each foaming operation. The advantage of this method is that the parting effect occurs without residues on the molded part and without affecting the chemical reaction. Harmful emissions are also avoided. However, this method is suitable exclusively for molded foam parts having closed foam surfaces; in addition, in this method high flow shearing forces occur during the foaming operation, which may result in artifacts due to limited foam collapse in the area directly underneath the foam surface of the artifacts. In addition, the process step of blowing in ionized air is time-consuming and affects productivity.

### DESCRIPTION OF THE INVENTION

The object of the present invention is to provide a molding tool which makes producing a molded foam body in a simple and cost-effective manner possible. The quality of the molded foam body regarding foam porosity and therefore acoustic effectiveness are to be enhanced. Flow shearing forces are also to be minimized.

This object is achieved by the features of Claim 1. In a molding tool of the above-mentioned type, the internal molding surfaces of the tool are provided with a microstructuring according to the lotus leaf effect and/or with a permanent anti-adhesion coating, e.g., using a fluorinated plastic or a diamond-like coating. It has been found that using the molding tool according to the present invention makes it possible to achieve a permanent parting effect. Furthermore, formation of skin is almost completely prevented, which is particularly important for the use of the molded foam bodies as acoustic components, for example, in the automobile industry, because the porous surface enhances sound absorbance. It has also been found that flow shearing forces in the surface areas of the molded foam body could be reduced. By reducing the flow shearing forces, the bubble structure becomes considerably more uniform, because the foam is not subjected to excessive mechanical stresses during the foaming process. This results in a considerably better molded foam body quality. This is advantageous in particular in the case of molded foam bodies in which the height/length and/or height/width ratio is small, because in those components the portion of the volume affected by flow shearing forces is particularly great. The reduced flow resistance reduces the internal pressure in the mold required to fill the cavity during the foaming process. This ultimately results in lighter tools and tool carriers. The material consumption is reduced due to a reduced lateral waste in the aeration region. Finally, the specific weight of the finished molded foam body may be reduced, because the material used is processable at a lower internal pressure.

The design and manufacture of a surface having a lotus leaf-type microstructure is known per se. In this case it is used on the internal shaping surfaces of the tool. Fluorinated plastics such as polytetrafluoroethylene (PTFE) or a mixture of tetrafluoroethylene and fluorovinyl ether (PFA) or a tetrafluoroethylene-hexafluoropropylene compound (FEP) may be used for the anti-adherence layer. Fluorinated plastics made of polyethylene-chlorotrifluoroethylene (ECTFE) or polyvinylidenefluoride (PVD F) are suitable for this purpose. Doped diamond-like coating layers are also suitable, for example.

Good results are achieved using either microstructuring of the internal surfaces according to the lotus leaf effect or a permanent anti-adherence coating. It is, however, also possible to use both measures jointly, i.e., to apply a permanent fluorinated plastic anti-adherence coating together with a lotus leaf-type microstructuring onto the internal surface.

An advantageous refinement of the present invention results from the fluorine-based anti-adherence coating having a wear-resistant hard material component. This enhances the hardness and wear resistance of the coating. A ceramic material is preferably used here. Due to their structure, diamond-like coatings have high wear resistance and are used for wear protection among other things.

The thickness of the anti-adherence layer is 10 μm to 100 μm, preferably 20 μm to 50 μm for fluorinated plastics and 1 μm to 50 μm, preferably 2 μm to 20 μm for diamond-like coatings.

The lotus leaf effect microstructuring may be applied directly to the internal surfaces of the tool. However, a coating of the internal surfaces into which the microstructuring is then applied may also be provided.

The design of the molding tool results in a long service life of the tool, which reduces the manufacturing costs of the molded foam bodies. In particular, the very thin anti-adherence layers have an effect on the reproduction of very fine structures in the molded foam body, so that the geometry does not need to be changed with respect to an uncoated shaping surface.

In summary, the present invention prevents production fluctuations and waste. At the same time, the cycle time in manufacturing is reduced, which increases productivity. The internal pressure in the mold and the mold space volume are also reduced, and the absorption surface is increased. Finally, flow shearing effects are prevented.

The appended figure shows comparative measurements of sound absorption by molded foam bodies, manufactured according to the conventional method using a parting agent and using a molding tool having an anti-adherence coating. The curves show the equivalent absorption surface A in m² as a function of frequency Hz. The solid curve shows the values measured for a molded foam body produced using a tool having an anti-adherence coating. The dashed curve, in contrast, shows the values measured for a molded foam body produced in a tool using parting agents. The molded foam body produced using the novel molding tool showed considerably improved sound absorption.

The appended drawing shows the effects of the present invention on the molded foam part.

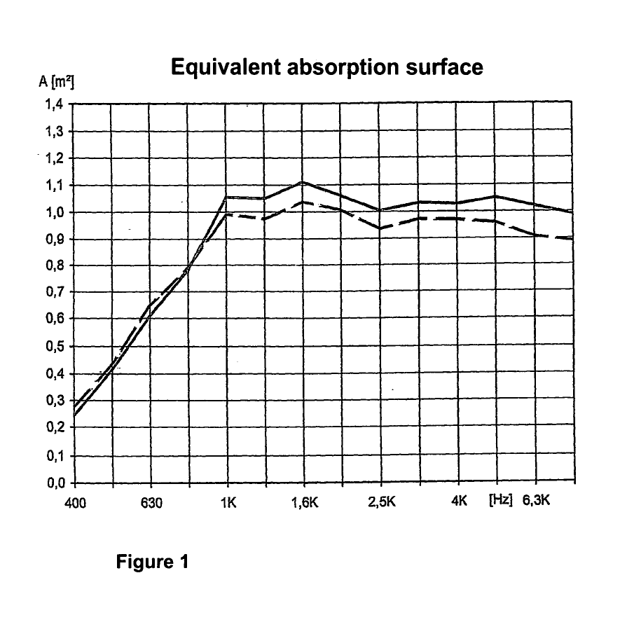

FIG. 1 shows a greatly enlarged top view of the surface of a molded foam part having projections for skin formation caused by the use of parting agents.

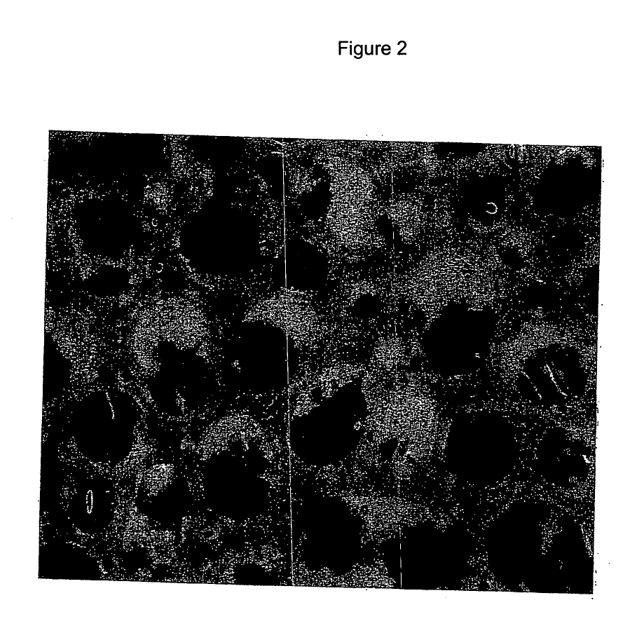

FIG. 2 shows a greatly enlarged top view of the surface of a molded foam part having a porous foam surface from a cavity equipped according to the present invention without skin formation.

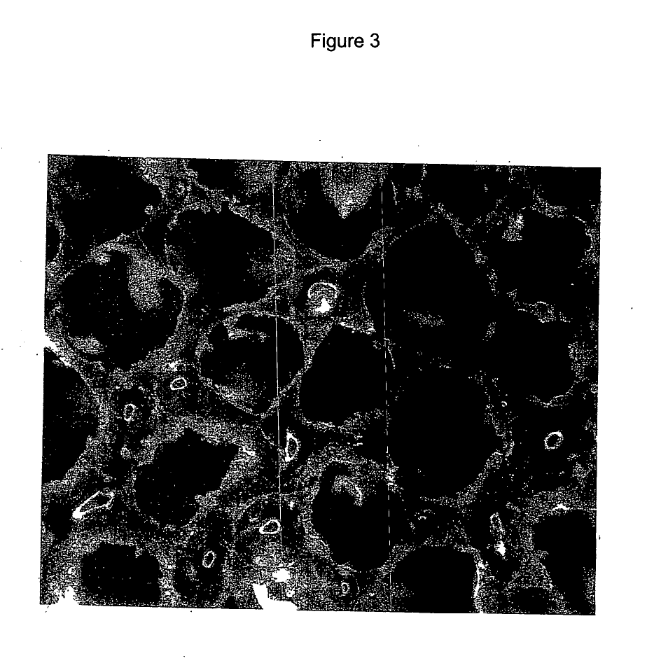

FIG. 3 shows a greatly enlarged top view of the surface of a molded foam part having projections for skin formation caused by the use of parting agents.

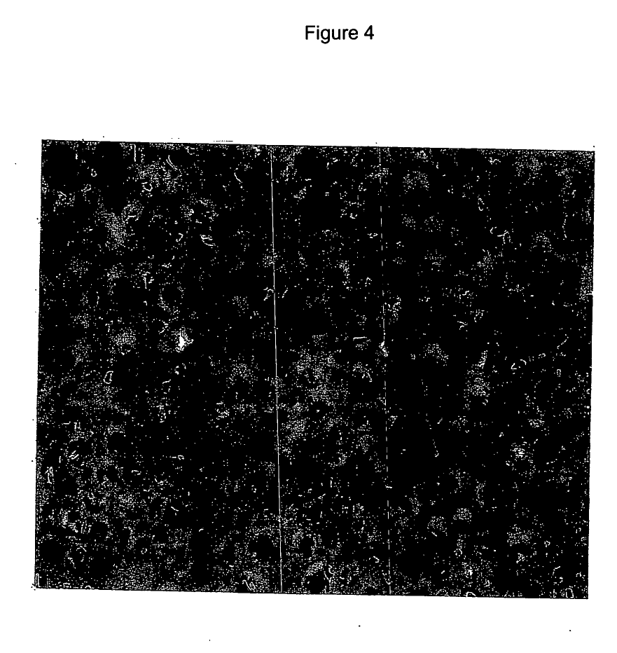

FIG. 4 shows a greatly enlarged top view of the surface of a molded foam part having a porous foam surface from a cavity equipped according to the present invention without skin formation.

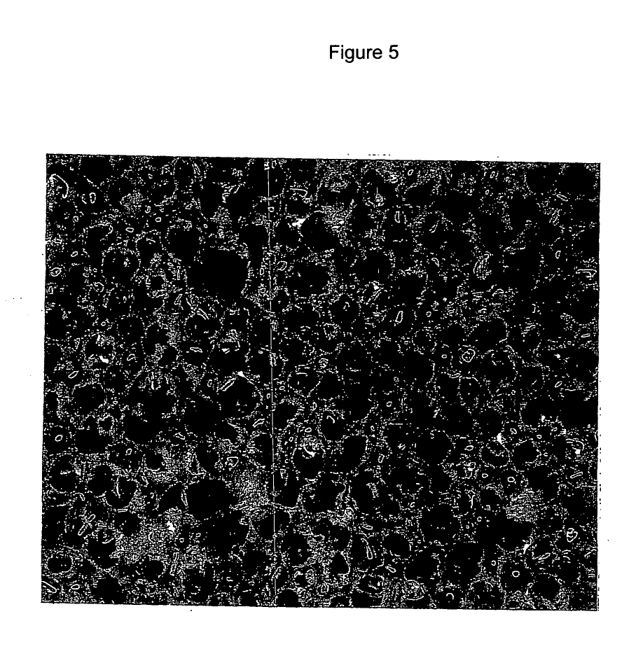

FIG. 5 shows the enlarged view of a section of the surface region of a molded foam part having visible distortions of the bubble structure and artifacts caused by flow shearing forces.

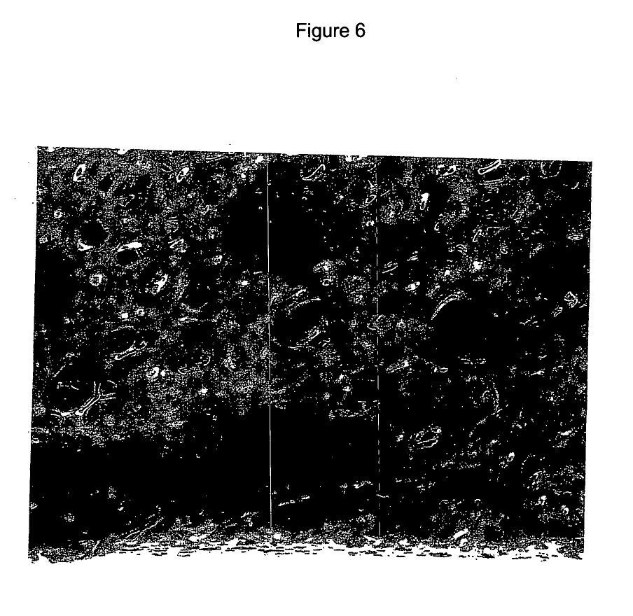

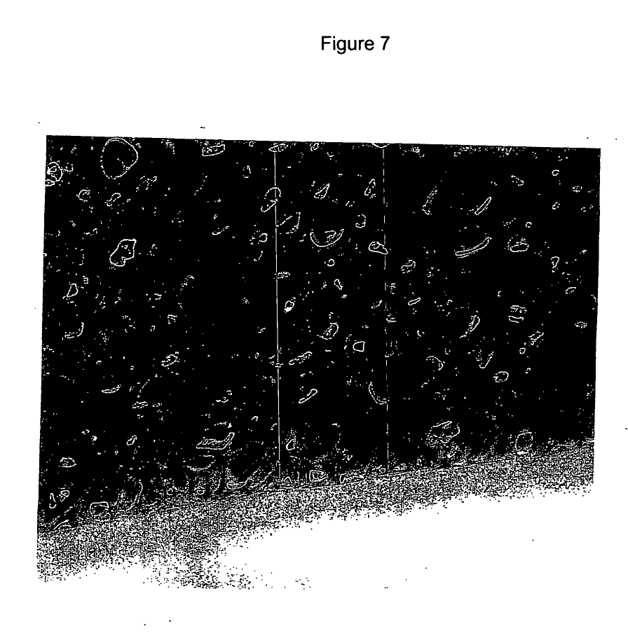

FIG. 6 shows the enlarged view of a section of the surface region of a molded foam part from a cavity equipped according to the present invention without distortions of the bubble structure.

1-5. (canceled)

6. A molding tool for producing molded foam bodies by filling an expandable reactive mixture into a mold comprising:
shaping internal surfaces having a lotus leaf-type microstructuring or a permanent anti-adherence coating made of a fluorinated plastic or a diamond-like coating.

7. The molding tool as recited in claim 6 wherein the internal surfaces have the anti-adherence coating, the anti-adhesive coating having a wear-resistant hard material component.

8. The molding tool as recited in claim 7 wherein the hard material is a ceramic material.

9. The molding tool as recited in claim 6 wherein the internal surfaces have the the anti-adherence coating, the anti-adherence coating being made of a fluorinated plastic having a thickness of 1 μm to 100 μm.

10. The molding tool as recited in claim 9 wherein the anti-adherence coating has a thickness of 2 μm to 50 μm.

10. The molding tool as recited in claim 6 wherein the internal surfaces have the anti-adherence coating, the anti-adherence coating being made of a diamond-like coating having a thickness of 1 μm to 50 μm.

11. The molding tool as recited in claim 10 wherein the anti-adherence coating has a thickness of 2 μm to 20 μm.

12. The molding tool as recited in claim 6 wherein the molding tool is a polyurethane molded foam body molding tool.
